(19) United States
(12) Patent Application Publication
(10) Pub. No.: US 2019/0078617 A1
(43) Pub. Date: Mar. 14, 2019

(54) DYNAMIC PRESSURE BEARING AND METHOD FOR MANUFACTURING SAME

(71) Applicant: NTN CORPORATION, Osaka (JP)

(72) Inventor: Kazuyoshi HARADA, Mie (JP)

(21) Appl. No.: 16/082,563

(22) PCT Filed: Feb. 28, 2017
(86) PCT No.: PCT/JP2017/007739

§ 371 Date: Sep. 6, 2018

(30) Foreign Application Priority Data
Mar. 16, 2016 (JP) 2016-052443

(51) Int. Cl. F16C 33/10; F16C 33/12; F16C 33/14; F16C 17/02

(52) U.S. Cl. CPC F16C 33/107; F16C 17/026; F16C 33/14; F16C 33/12

(57) ABSTRACT

The fluid dynamic bearing including: a pair of bearing surfaces (8a1 and 8a2) having dynamic pressure generating grooves (G1 and G2) on an inner peripheral surface (8a); a pair of first smooth surfaces (8a4 and 8a5) formed between both the bearing surfaces (8a1 and 8a2) so as to be adjacent to the respective bearing surfaces (8a1 and 8a2); and a relief portion (8a3), which is formed between both the first smooth surfaces (8a4 and 8a5), and has a diameter larger than those of the pair of bearing surfaces (8a1 and 8a2).

### TECHNICAL FIELD

The present invention relates to a fluid dynamic bearing having dynamic pressure generating grooves formed in an inner peripheral surface thereof, and a method of manufacturing the same.

### BACKGROUND ART

A fluid dynamic bearing is configured to relatively rotatably support a shaft by a dynamic pressure generating action of a fluid film, which is generated in a bearing gap between the fluid dynamic bearing and the shaft inserted along an inner periphery thereof. Specifically, along with relative rotation between the fluid dynamic bearing and the shaft, by the dynamic pressure generating grooves formed in an inner peripheral surface of the fluid dynamic bearing, a pressure of the fluid film of the bearing gap between an inner peripheral surface of the fluid dynamic bearing and an outer peripheral surface of the shaft is increased. With this, the shaft is supported in a non-contact manner.

In Patent Literature 1, a method of molding dynamic pressure generating grooves in an inner peripheral surface of a fluid dynamic bearing is disclosed. In this method, in a state in which a core rod having molding patterns on an outer peripheral surface thereof is inserted along an inner periphery of a bearing preform (sintered metal preform), the bearing preform is press-fitted along an inner periphery of a die. Thus, the bearing preform is pressed radially inward, and an inner peripheral surface of the bearing preform is pressed against the molding patterns on the outer peripheral surface of the core rod. With this, shapes of the molding patterns are transferred onto the inner peripheral surface of the bearing preform so that bearing surfaces having the dynamic pressure generating grooves are molded.

Further, in the fluid dynamic bearing, a relief portion having a diameter larger than a diameter of the bearing surfaces is formed between the pair of bearing surfaces formed on the inner peripheral surface so as to reduce a relative rotational torque of the shaft in some cases. For example, in Patent Literature 2, there is disclosed a method of manufacturing a fluid dynamic bearing having a pair of bearing surfaces and a relief portion formed therebetween. In the manufacturing method, in a state in which a core rod having molding patterns on an outer peripheral surface thereof is inserted along an inner periphery of a cylindrical bearing preform (sintered body), the bearing preform is press-fitted along an inner periphery of a die to press two regions of an outer peripheral surface of the bearing preform, which are separated from each other in an axial direction, radially inward. With this, two regions of an inner peripheral surface of the bearing preform, which are separated from each other in the axial direction, are pressed against the molding patterns of the core rod to mold the bearing surfaces having dynamic pressure generating grooves in the respective regions. At this time, an axial center part of the inner peripheral surface of the bearing preform does not receive a pressing force acting radially inward. Thus, the axial center part has a diameter larger than those of the bearing surfaces, and this part serves as the relief portion.

### CITATION LIST

Patent Literature 1: JP 11-190344 A

Patent Literature 2: JP 3954695 B2

### SUMMARY OF INVENTION

### Technical Problem

In Patent Literature 2 described above, as illustrated in FIG. 10 in an exaggerated manner, on an inner peripheral surface of a fluid dynamic bearing 108, a pair of bearing surfaces 108a having dynamic pressure generating grooves G and a relief portion 108b formed between the pair of bearing surfaces 108a are adjacent to each other. The bearing surfaces 108a and the relief portion 108b are adjacent to each other as described above. Thus, at each of end portions of the respective bearing surfaces 108a on the relief portion 108b side, so-called “shear droop” is liable to occur (see δ of FIG. 10). The reason thereof is as described below. That is, after the inner peripheral surface of the bearing preform is pressed against the molding patterns of the core rod to mold the bearing surfaces, the pressing force acting radially inward, which is applied to the bearing preform, is released. Then, the bearing surfaces are radially expanded due to springback to be separated from the molding patterns of the core rod. At this time, amounts of radial expansion of the bearing surfaces are not uniform, and the end portions on the relief portion side are pulled to the radially outer side by the relief portion. Therefore, amounts of radial expansion of the end portions of the respective bearing surfaces 108a on the relief portion 108b side are slightly larger than amounts of radial expansion of axial center parts of the respective bearing surfaces 108a. With this, the shear droop δ is liable to occur at each of the end portions of the respective bearing surfaces 108a on the relief portion 108b side. When the shear droop occurs at each of the end portions of the bearing surfaces as described above to degrade the dimension accuracy (cylindricity) of the bearing surfaces, the oil film formation ability is degraded, thus leading to reduction in bearing rigidity.

In view of the above, the present invention has an object to suppress shear droop at each of end portions of bearing surfaces and to enhance the bearing rigidity in a fluid dynamic bearing comprising the pair of bearing surfaces having dynamic pressure generating grooves and a relief portion formed therebetween.

### Solution to Problem

According to one embodiment of the present invention, provided is a method of manufacturing a fluid dynamic bearing, comprising: inserting a core rod along an inner periphery of a bearing preform having a cylindrical shape, the core rod comprising a pair of molding patterns separated from each other in an axial direction and a first cylindrical region formed between the pair of molding patterns so as to be adjacent to the respective molding patterns, which are formed on an outer peripheral surface of the core rod; and pressing two regions of an inner peripheral surface of the bearing preform, which are separated from each other in the axial direction, against the molding patterns and the first cylindrical region of the core rod by pressing two regions of an outer peripheral surface of the bearing preform, which are separated from each other in the axial direction, radially inward to mold, on the inner peripheral surface of the bearing preform, a pair of bearing surfaces having dynamic pressure generating grooves and a pair of first smooth surfaces formed between the pair of bearing surfaces so as to be adjacent to the respective bearing surfaces, and to form a relief portion between the pair of first smooth surfaces, the relief portion having a diameter larger than a diameter of the pair of bearing surfaces.

As described above, in one embodiment of the present invention, the outer peripheral surface of the bearing preform is pressed radially inward. Thus, the inner peripheral surface of the bearing preform is pressed not only against the molding patterns of the core rod, but also against the first cylindrical region adjacent to the molding patterns. In this manner, at the same time of molding the bearing surfaces, the first smooth surfaces adjacent to the bearing surfaces are molded. That is, to such a degree that the first smooth surfaces are actively molded in regions adjacent to the respective bearing surfaces, a pressed region of the outer peripheral surface of the bearing preform is expanded to the inner side in the axial direction with respect to the pair of molding patterns. As described above, the respective bearing surfaces and the relief portion are not adjacent to each other, and the first smooth surfaces are formed therebetween. Thus, regions liable to be increased in diameter due to an influence of the relief portion at the time of releasing the pressing force correspond to the first smooth surfaces. Therefore, the influence of the relief portion does not reach the bearing surfaces almost at all, thereby being capable of suppressing shear droop at each of the end portions of the pair of bearing surfaces on the inner side in the axial direction (relief portion side).

Incidentally, chamfered portions are generally formed on both axial end portions of the outer peripheral surface and the inner peripheral surface of the bearing preform. However, when the bearing preform is pressed radially inward to form the bearing surfaces as described above, the chamfered portions are not pressed in many cases. At this time, in a case where the bearing surfaces and the chamfered portions are adjacent to each other, when the bearing preform is to be pressed, pressures applied to end portions of the bearing surfaces on the outer sides in the axial direction (chamfered portion sides) escape to the chamfered portions. Therefore, those parts are not pressed against the molding patterns of the core rod sufficiently, and there is a fear in that the molding accuracy for the end portions of the pair of bearing surfaces on the outer sides in the axial direction may be degraded.

Therefore, it is preferred that, a pair of second cylindrical regions adjacent to the respective molding patterns be formed on outer sides of the pair of molding patterns in the axial direction in the outer peripheral surface of the core rod, and, when the two regions of the outer peripheral surface of the bearing preform, which are separated from each other in the axial direction, are pressed, the two regions of the inner peripheral surface of the bearing preform, which are separated from each other in the axial direction, be further pressed against the pair of second cylindrical regions of the core rod to mold a pair of second smooth surfaces on the inner peripheral surface of the bearing preform on outer sides of the pair of bearing surfaces in the axial direction so as to be adjacent to the respective bearing surfaces. When the second smooth surfaces adjacent to the outer sides of the pair of bearing surfaces in the axial direction are formed as described above, the respective bearing surfaces are separated from the end portions of the inner peripheral surface in the axial direction (chamfered portions). With this, regions susceptible to the influence of the chamfered portions at the time of releasing a pressing force correspond to the second smooth surfaces. Therefore, the influence of the chamfered portions does not reach the bearing surfaces almost at all, thereby being capable of enhancing the molding accuracy for the end portions of the pair of bearing surfaces on the outer sides in the axial direction.

In the fluid dynamic bearing configured to support a large moment load, in order to increase the moment rigidity, a bearing span (axial interval between maximum pressure generating portions of the pair of bearing surfaces) is increased in some cases. In such a fluid dynamic bearing, in order to obtain large moment rigidity, it is required to mold every part of the bearing surfaces with high accuracy including the axial end portions so as to sufficiently increase an oil film pressure. Therefore, it is particularly effective that such a manufacturing method be applied to the fluid dynamic bearing having a large bearing span (specifically, a fluid dynamic bearing with a ratio L/D of an axial length L to an inner diameter D being 5 or more). Further, in the fluid dynamic bearing having a large bearing span, a non-compressive region between the pair of bearing surfaces is sufficiently large. With this, even when the above-mentioned manufacturing method is applied to the fluid dynamic bearing having a large bearing span, and the pair of first smooth surfaces adjacent to the respective bearing surfaces are formed, an axial length of the relief portion formed between the pair of first smooth surfaces can be sufficiently secured. Thus, the relief portion can be easily and sufficiently increased in diameter. Therefore, when the above-mentioned manufacturing method is applied to the fluid dynamic bearing having a large bearing span, highly accurate bearing surfaces can be molded while avoiding increase in rotational torque due to reduction in diameter of the relief portion, thereby being capable of increasing the moment rigidity.

According to the above-mentioned manufacturing method, provided is a fluid dynamic bearing comprising:

an inner peripheral surface comprising:
a pair of bearing surfaces, which are formed in two regions separated from each other in an axial direction, and have dynamic pressure generating grooves;
a pair of first smooth surfaces formed between the pair of bearing surfaces so as to be adjacent to the respective bearing surfaces; and
a relief portion formed between the pair of first smooth surfaces, and has a diameter larger than a diameter of the pair of bearing surfaces; and

an outer peripheral surface having pressure marks formed in entire axial regions covering the pair of bearing surfaces and the pair of first smooth surfaces. In the fluid dynamic bearing, shear droop at each of the end portions of the bearing surfaces is small, and hence the fluid dynamic bearing has high oil film formation ability.

The first smooth surfaces of the above-mentioned fluid dynamic bearing are molded by being pressed by the first cylindrical region of the core rod, and hence each have a substantially cylindrical surface shape. However, when, after the bearing surfaces and the first smooth surfaces are molded, a pressing force acting radially inward, which is applied to the fluid dynamic bearing, is released so that the bearing surfaces and the first smooth surfaces of the fluid dynamic bearing are radially expanded due to springback, the end portions of the first smooth surfaces on the relief portion side are pulled to the radially outer side by the relief portion, and hence have an amount of radial expansion slightly larger than those of other regions. Therefore, each of the first smooth surfaces is not a perfect cylindrical surface but an inclined surface (substantially tapered surface) having a diameter gradually increased toward the relief portion side and being slightly inclined with respect to the axial direction.

In the above-mentioned fluid dynamic bearing, radial positions of the first smooth surfaces and the second smooth surfaces are not particularly limited. For example, when one or both of the first smooth surfaces and the second smooth surfaces are formed so as to be continuous with the dynamic pressure generating grooves of the adjacent bearing surfaces, as compared to a case in which the one or both of the first smooth surfaces and the second smooth surfaces are formed so as to be continuous with hill portions of the bearing surfaces, a gap between the shaft and each of the first smooth surfaces and the second smooth surfaces is increased, thereby being capable of reducing the relative rotational torque of the shaft.

In the above-mentioned fluid dynamic bearing, in order to reliably prevent the shear droop at each of the end portions of the bearing surfaces, it is desired that the axial dimension of the first smooth surface be increased to some extent. Specifically, it is preferred that an axial distance L1′ between one axial end surface of the fluid dynamic bearing and an end portion of one of the first smooth surfaces, which is close to the one axial end surface, on the relief portion side be set to more than 1.25 times larger than an axial distance L1 between the one axial end surface and an end portion of one of the bearing surfaces, which is close to the one axial end surface, on the relief portion side.

### Advantageous Effects of Invention

As described above, at the time of forming the pair of bearing surfaces on the inner peripheral surface of the fluid dynamic bearing, the first smooth surfaces are molded on the regions adjacent to the respective bearing surfaces. Thus, shear droop at each of the end portions of the pair of bearing surfaces on the inner side in the axial direction can be suppressed. Accordingly, the oil film formation ability of the bearing surfaces and the bearing rigidity can be enhanced.

### BRIEF DESCRIPTION OF DRAWINGS

FIG. 1 is a sectional view of a fan motor.

FIG. 2 is a sectional view of a fluid dynamic bearing device.

FIG. 3 is a sectional view of a fluid dynamic bearing according to one embodiment of the present invention.

FIG. 4 is a sectional view for illustrating a shape of an inner peripheral surface of the fluid dynamic bearing of FIG. 3 in an exaggerated manner.

FIG. 5 is a sectional view of a bearing preform being a precursor of the fluid dynamic bearing of FIG. 3.

FIG. 6 is a sectional view for illustrating a state in which a sizing step is performed on the bearing preform before the bearing preform is press-fitted along an inner periphery of a die.

FIG. 7 is a front view of molding patterns formed on a core rod.

FIG. 8 is a sectional view for illustrating a state in which the sizing step is performed on the bearing preform when the bearing preform is press-fitted along the inner periphery of the die.

FIG. 9 is a graph for showing a result of a test conducted to verify a preferred axial dimension of a first smooth surface.

FIG. 10 is a sectional view for illustrating a state in which shear droop occurs at each of bearing surfaces of the fluid dynamic bearing.

### DESCRIPTION OF EMBODIMENTS

Now, an embodiment of the present invention is described with reference to the drawings.

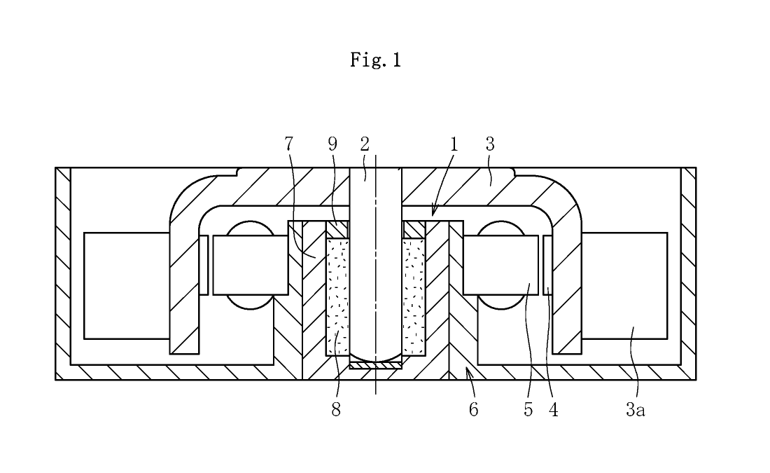

A fan motor illustrated in FIG. 1 comprises a fluid dynamic bearing device 1, a motor base 6, stator coils 5 fixed to the motor base 6, a rotor 3 comprising blades 3a, and a rotor magnet 4 being fixed to the rotor 3 and facing the stator coils 5 across a radial gap. A housing 7 of the fluid dynamic bearing device 1 is fixed to an inner periphery of the motor base 6, and the rotor 3 is fixed to one end of a shaft 2 of the fluid dynamic bearing device 1. In the fan motor having such a configuration, when the stator coils 5 are energized, an electromagnetic force is generated between the stator coils 5 and the rotor magnet 4 to cause the rotor magnet 4 to rotate. In conjunction therewith, the shaft 2, the rotor 3, and the rotor magnet 4 are rotated so that the blades 3a provided to the rotor 3 generate, for example, airflow in an axial direction.

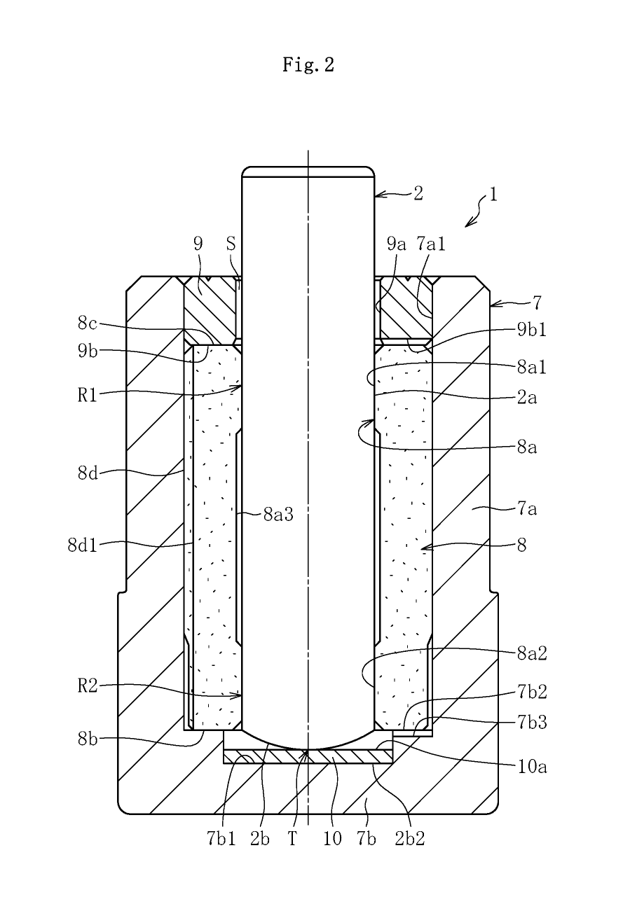

As illustrated in FIG. 2, the fluid dynamic bearing device 1 comprises a fluid dynamic bearing 8 according to one embodiment of the present invention, the shaft 2 inserted along an inner periphery of the fluid dynamic bearing 8, the bottomed cylindrical housing 7 having the fluid dynamic bearing 8 fixed to an inner periphery thereof, and a sealing member 9 arranged in an opening portion of the housing 7. In the following description of the fluid dynamic bearing device 1, the opening side of the housing 7 in the axial direction is referred to as an upper side, and a side opposite thereto is referred to as a lower side. This definition is not intended to limit a mode of use of the fluid dynamic bearing device 1.

The shaft 2 is made of a metal material such as stainless steel. The shaft 2 comprises an outer peripheral surface 2a having a smooth cylindrical surface shape, and a projecting portion 2b having a spherical shape, which is formed at a lower end. An outer diameter of the shaft 2 is, for example, from about 1 mm to about 4 mm.

The housing 7 comprises a cylindrical side portion 7a, and a bottom 7b closing a lower end of the side portion 7a. The housing 7 is formed of metal or resin. In this embodiment, the side portion 7a and the bottom 7b are integrally formed of metal. On a radially outer end of an upper end surface 7b1 of the bottom 7b, a shoulder surface 7b2 located on an upper side with respect to a center part of the upper end surface 7b1 of the bottom 7b is formed, and a lower end surface 8b of the fluid dynamic bearing 8 is held in abutment against the shoulder surface 7b2. A radial groove 7b3 is formed in the shoulder surface 7b2. A thrust receiver 10 made of resin is arranged at the center part of the upper end surface 7b1 of the bottom 7b.

The fluid dynamic bearing 8 has a cylindrical shape, and is fixed to an inner peripheral surface 7a1 of the side portion 7a of the housing 7 by a suitable measure such as bonding, press fitting, or press fitting through use of an adhesive. The fluid dynamic bearing 8 is formed of metal or resin. As the metal, there may be used, for example, an ingot material (such as a copper alloy or an iron alloy) or sintered metal. The fluid dynamic bearing 8 of this embodiment is formed of copper-based sintered metal, iron-based sintered metal, or copper-iron based sintered metal.

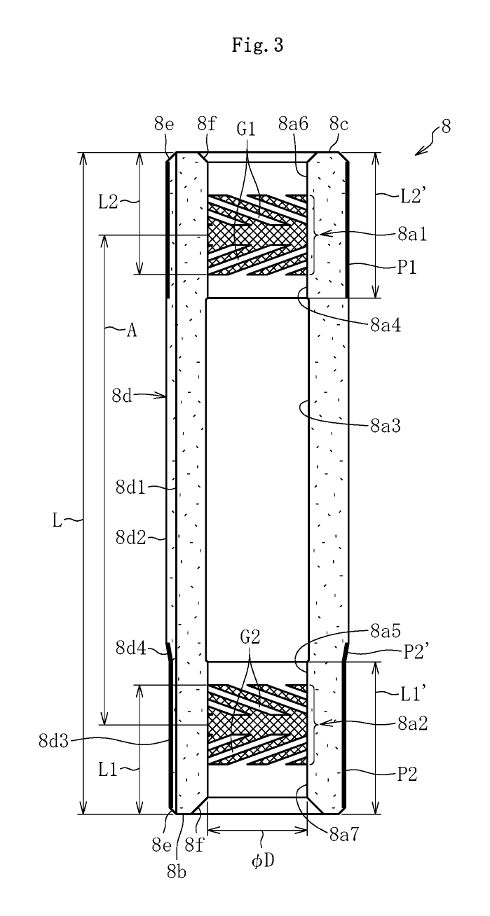

As illustrated in FIG. 3, in two regions of an inner peripheral surface of the fluid dynamic bearing 8, which are separated from each other in the axial direction, bearing surfaces 8a1 and 8a2 are formed. Dynamic pressure generating grooves are formed in the bearing surfaces 8a1 and 8a2, respectively. In the illustrated example, dynamic pressure generating grooves G1 and G2 in a herringbone pattern are formed. Regions indicated by cross hatching in FIG. 3 correspond to hill portions that budge to the radially inner side, and regions partitioned by the hill portions correspond to the dynamic pressure generating grooves G1 and G2. In the illustrated example, both of the dynamic pressure generating grooves G1 and G2 have a symmetrical shape in the axial direction.

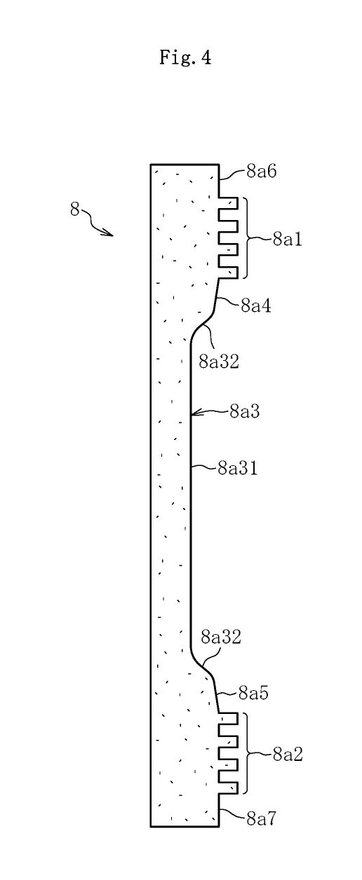

A relief portion 8a3 is formed between the bearing surfaces 8a1 and 8a2 on the inner peripheral surface of the fluid dynamic bearing 8 in the axial direction. The relief portion 8a3 has a diameter larger than those of the bearing surfaces 8a1 and 8a2 (specifically, the dynamic pressure generating grooves G1 and G2). As illustrated in FIG. 4 in an exaggerated manner, the relief portion 8a3 comprises a substantially cylindrical region 8a31 that occupies a most part excluding both ends in the axial direction, and inclined regions 8a32 allowing the substantially cylindrical region 8a31 and each of the first smooth surfaces 8a4 and 8a5 to be continuous with each other.

On the inner peripheral surface of the fluid dynamic bearing 8, the first smooth surfaces 8a4 and 8a5 are formed on inner sides with respect to the pair of bearing surfaces 8a1 and 8a2 in the axial direction (relief portion 8a3 side), respectively. The first smooth surface 8a4 on the upper side is adjacent to the bearing surface 8a1 on the upper side and the relief portion 8a3, and the first smooth surface 8a5 on the lower side is adjacent to the bearing surface 8a2 on the lower side and the relief portion 8a3. In the illustrated example, the first smooth surfaces 8a4 and 8a5 are formed so as to be continuous with the dynamic pressure generating grooves G1 and G2 in the bearing surfaces 8a1 and 8a2. The first smooth surfaces 8a4 and 8a5 have a substantially cylindrical surface shape. However, as illustrated in FIG. 4 in an exaggerated manner, the first smooth surfaces 8a4 and 8a5 do not have a perfect cylindrical surface, but have an inclined surface (substantially tapered surface) that is gradually radially expanded toward the relief portion 8a3 side (axial center side of the fluid dynamic bearing 8) and is slightly inclined with respect to the axial direction. The inclination percentage of the first smooth surfaces 8a4 and 8a5 with respect to the axial direction is, for example, less than 1%.

An axial distance L1′ between the lower end surface 8b of the fluid dynamic bearing 8 and an upper end of the first smooth surface 8a5 on the lower side is more than 1.25 times as large as, preferably, more than 1.35 times as large as an axial distance L1 between the lower end surface 8b and an upper end of the bearing surface 8a2 on the lower side. Similarly, an axial distance L2′ between the upper end surface 8c of the fluid dynamic bearing 8 and a lower end of the first smooth surface 8a4 on the upper side is more than 1.25 times as large as, preferably, more than 1.35 times as large as an axial distance L2 between the upper end surface 8c and a lower end of the bearing surface 8a1 on the upper side.

On the inner peripheral surface of the fluid dynamic bearing 8, second smooth surfaces 8a6 and 8a7 are formed on outer sides with respect to the pair of bearing surfaces 8a1 and 8a2 in the axial direction (sides opposite to the relief portion 8a3), respectively. The second smooth surfaces 8a6 and 8a7 are adjacent to the bearing surfaces 8a1 and 8a2, respectively. In the illustrated example, the second smooth surfaces 8a6 and 8a7 are formed so as to be continuous with the dynamic pressure generating grooves G1 and G2. The second smooth surfaces 8a6 and 8a7 reach an upper end and a lower end of an inner peripheral surface 8a, respectively, and are adjacent to chamfered portions 8f formed on the upper end and the lower end of the inner peripheral surface 8a. The second smooth surfaces 8a6 and 8a7 have a substantially cylindrical surface shape. In this embodiment, as illustrated in FIG. 4, the second smooth surfaces 8a6 and 8a7 have an almost perfect cylindrical surface. However, similarly to the first smooth surfaces 8a4 and 8a5, each of the second smooth surfaces 8a6 and 8a7 may be an inclined surface that is slightly inclined with respect to the axial direction. In this case, the second smooth surfaces 8a6 and 8a7 are gradually radially expanded toward sides opposite to the relief portion 8a (end portion sides of the fluid dynamic bearing 8 in the axial direction). The inclination angle of the second smooth surfaces 8a6 and 8a7 with respect to the axial direction is smaller than the inclination angle of the first smooth surfaces 8a4 and 8a5 with respect to the axial direction.

On the inner peripheral surface 8a of the fluid dynamic bearing 8, the bearing surfaces 8a1 and 8a2 (dynamic pressure generating grooves G1 and G2 and hill portions), the first smooth surfaces 8a4 and 8a5, and the second smooth surfaces 8a6 and 8a7 are surfaces having been subjected to molding in a sizing step described later. In contrast, the molding in the sizing step described later is not performed on the relief portion 8a3 of the inner peripheral surface 8a of the fluid dynamic bearing 8 and the chamfered portions 8f formed on the upper and lower ends of the inner peripheral surface 8a. Therefore, the relief portion 8a3 and the chamfered portions 8f have higher surface roughnesses and higher surface aperture ratios than the bearing surfaces 8a1 and 8a2, the first smooth surfaces 8a4 and 8a5, and the second smooth surfaces 8a6 and 8a7.

An axial groove 8d1 is formed in an outer peripheral surface 8d of the fluid dynamic bearing 8. The axial groove 8d1 is formed in an entire axial length of the outer peripheral surface 8d of the fluid dynamic bearing 8, and both axial ends of the axial groove 8d1 reach chamfered portions 8e formed on an upper end and a lower end of the outer peripheral surface 8d of the fluid dynamic bearing 8. The outer peripheral surface 8d of the fluid dynamic bearing 8 comprises a large-diameter portion 8d2, a small-diameter portion 8d3 formed on the lower side with respect to the large-diameter portion 8d2, and a tapered portion 8d4 allowing the large-diameter portion 8d2 and the small-diameter portion 8d3 to be continuous with each other. An axial position at the boundary between the small-diameter portion 8d3 and the tapered portion 8d4 substantially matches with an axial position of the upper end of the first smooth surface 8a5 on the lower side, which is formed on the inner peripheral surface 8a.

In two regions of the outer peripheral surface 8d of the fluid dynamic bearing 8, which are separated from each other in the axial direction, pressure marks P1 and P2 are formed (indicated by the thick lines in FIG. 3). The pressure mark P1 on the upper side is formed on the outer peripheral surface 8d of the fluid dynamic bearing 8 in the entire axial region covering the bearing surface 8a1 on the upper side, the first smooth surface 8a4, and the second smooth surface 8a6, which are formed on the inner peripheral surface 8a. In the illustrated example, the pressure mark P1 on the upper side is formed on the outer peripheral surface 8d of the fluid dynamic bearing 8 in an axial region from an axial position of a lower end of the first smooth surface 8a4 to the chamfered portion 8e on the upper end of the outer peripheral surface 8d. The pressure mark P2 on the lower side is formed on the outer peripheral surface 8d of the fluid dynamic bearing 8 in the entire axial region covering the bearing surface 8a2 on the lower side, the first smooth surface 8a5, and the second smooth surface 8a7, which are formed on the inner peripheral surface 8a. In the illustrated example, the pressure mark P2 on the lower side is formed on the outer peripheral surface 8d of the fluid dynamic bearing 8 in an axial region from an axial position of the upper end of the first smooth surface 8a5 to the chamfered portion 8e on the lower end of the outer peripheral surface 8d (that is, an entire region of the small-diameter portion 8d3). In this embodiment, a pressure mark P2′ is also formed on the tapered portion 8d4 on the outer peripheral surface 8d of the fluid dynamic bearing 8. A pressure mark is not formed on the upper and lower chamfered portions 8e and in a region of the outer peripheral surface 8d of the fluid dynamic bearing 8 excluding the pressure marks P1, P2, and P2′ (that is, a region of the axial region of the relief portion 8a3 excluding the pressure mark P2′).

The fluid dynamic bearing 8 of this embodiment is large in the axial direction, and specifically, a ratio L/D of an axial length L to an inner diameter D is 5 or more (see FIG. 3). In this case, an interval between axial center parts (bearing span) of the bearing surfaces 8a1 and 8a2 can be increased. Specifically, a ratio A/D of an axial interval A between annular portions formed at the axial centers of the hill portions of the respective bearing surfaces 8a1 and 8a2 and the inner diameter D of the fluid dynamic bearing 8 can be set to 4 or more. The bearing span of the fluid dynamic bearing 8 is set large as described above, thereby increasing the bearing rigidity against a moment load applied to the shaft 2.

The sealing member 9 is formed of resin or metal into an annular shape, and is fixed to an upper end portion of the inner peripheral surface 7a1 of the housing 7 (see FIG. 2). A lower end surface 9b of the sealing member 9 is held in abutment against the upper end surface 8c of the fluid dynamic bearing 8. A radial groove 9b1 is formed in the lower end surface 9b of the sealing member 9. An inner peripheral surface 9a of the sealing member 9 is opposed to the outer peripheral surface 2a of the shaft 2 in the radial direction, and a seal space S is formed therebetween.

A lubricating oil as a lubricating fluid is injected into the fluid dynamic bearing device 1 comprising the above-mentioned components so that a radial bearing gap (gap between the bearing surfaces 8a1 and 8a2 of the fluid dynamic bearing 8 and the outer peripheral surface 2a of the shaft 2) is filled with the lubricating oil. Grease or a magnetic fluid may be used as the lubricating fluid besides the lubricating oil.

When the shaft 2 is rotated, the radial bearing gap is formed between the bearing surfaces 8a1 and 8a2 of the fluid dynamic bearing 8 and the outer peripheral surface 2a of the shaft 2. Then, a pressure of an oil film of the radial bearing gap is increased by the dynamic pressure generating grooves G1 and G2 formed in the bearing surfaces 8a1 and 8a2, and thus, there are formed a first radial bearing portion R1 and a second radial bearing portion R2 configured to rotatably support the shaft 2 in a non-contact manner. Further, the projecting portion 2b having a spherical shape at the lower end of the shaft 2 and an upper end surface 10a of the thrust receiver 10 slide against each other, thereby forming a thrust bearing portion T configured to rotatably support the shaft 2 in a contact manner.

In this embodiment, a space facing the lower end of the shaft 2 and the seal space S communicate with each other through the radial groove 7b3 of the shoulder surface 7b2 of the housing 7, the axial groove 8d1 of the outer peripheral surface 8d of the fluid dynamic bearing 8, and the radial groove 9b1 of the lower end surface 9b of the sealing member 9. With this, the space facing the lower end of the shaft 2 is constantly kept at a pressure close to an atmospheric pressure, thereby being capable of preventing generation of a negative pressure in the space. One or both of the dynamic pressure generating grooves G1 and G2 formed in the inner peripheral surface 8a of the fluid dynamic bearing 8 may be formed into an asymmetric shape in the axial direction so as to generate a pumping force of force-feeding the lubricating oil in the radial bearing gap downward along with the rotation of the shaft 2.

Now, a method of manufacturing the fluid dynamic bearing 8 is described.

First, a bearing preform 8′ illustrated in FIG. 5 is formed. The bearing preform 8′ in this embodiment is formed of sintered metal. The bearing preform 8′ has a substantially cylindrical shape, and an inner peripheral surface 8a′ thereof has a smooth cylindrical surface in an entire region. An outer peripheral surface 8d′ of the bearing preform 8′ comprises a large-diameter portion 8d2′, and a small-diameter portion 8d3′ formed on the lower side with respect to the large-diameter portion 8d2 ‘. An axial groove 8d1’ is formed in an entire length of the outer peripheral surface 8d′ of the bearing preform 8′. Chamfered portions 8f′ are formed on an upper end and a lower end of the inner peripheral surface 8a′ of the bearing preform 8′, and chamfered portions 8e′ are formed on an upper end and a lower end of the outer peripheral surface 8d′ of the bearing preform 8′. The inner diameter of the bearing preform 8′ is substantially equal to the inner diameter of the relief portion 8a3 (substantially cylindrical region 8a31) of the fluid dynamic bearing 8 illustrated in FIG. 3. The outer diameter of the small-diameter portion 8d3′ on the outer peripheral surface 8d′ of the bearing preform 8′ is substantially equal to the outer diameter of the large-diameter portion 8d2 of the outer peripheral surface 8d of the fluid dynamic bearing 8.

Specifically, the bearing preform 8′ is manufactured in the following procedure. First, various types of powder are mixed to prepare raw material powder (mixing step). For example, main component metal powder such as copper-based metal powder or iron-based metal powder, low-melting point metal powder such as tin powder, zinc powder, or phosphorus alloy powder, and solid lubricant powder such as graphitic powder are mixed to prepare the raw material powder. Various types of molding lubricant (for example, lubricant for enhancing mold releasability) may be added to the raw material powder as required. Further, the low-melting point metal powder or the solid lubricant powder may be omitted unless otherwise required. The above-mentioned raw material powder is subjected to compression molding through use of a forming die (not shown) to obtain a compact having substantially the same shape as that of the bearing preform 8′ illustrated in FIG. 5 (powder compacting step). After that, the compact is sintered at a predetermined sintering temperature to obtain the bearing preform 8′ formed of a sintered metal (sintering step).

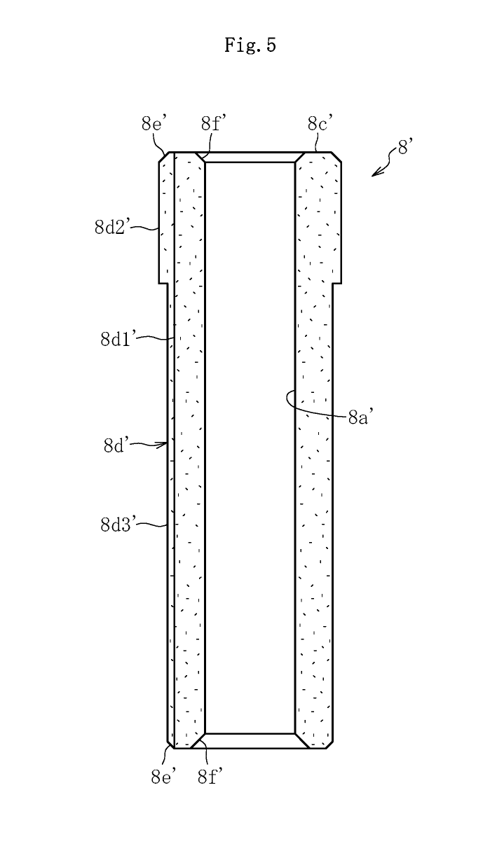

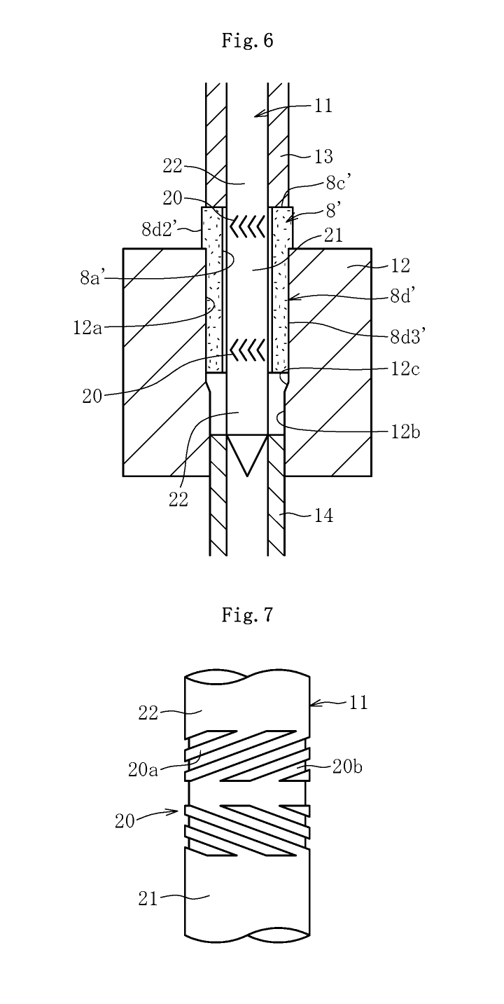

Next, the bearing preform 8′ is molded through use of a sizing die illustrated in FIG. 6, and the bearing surfaces 8a1 and 8a2 having the dynamic pressure generating grooves G1 and G2 are molded in the inner peripheral surface 8a′ of the bearing preform 8′ (sizing step).

The sizing die comprises a core rod 11, a die 12, an upper punch 13, and a lower punch 14. In two regions of the outer peripheral surface of the core rod 11, which are separated from each other in the axial direction, molding patterns 20 are formed. As illustrated in FIG. 7, the molding patterns 20 each comprise projecting portions 20a configured to mold the dynamic pressure generating grooves G1 or the dynamic pressure generating grooves G2, and recessed portions 20b configured to mold the hill portions (FIG. 7 is an illustration of the molding pattern 20 on the upper side). A region of the outer peripheral surface of the core rod 11 excluding the molding patterns 20 is a smooth cylindrical surface. Specifically, a first cylindrical region 21 is formed between the pair of molding patterns 20, and second cylindrical regions 22 are formed on outer sides of the pair of molding patterns 20 in the axial direction, respectively. In the illustrated example, the cylindrical regions 21 and 22 are continuous with the projecting portions 20a of the adjacent molding patterns 20 on the same cylindrical surface. On the inner peripheral surface of the die 12, there are formed a large-diameter portion 12a, a small-diameter portion 12b formed on the lower side with respect to the large-diameter portion 12a, and a tapered portion 12c allowing the large-diameter portion 12a and the small-diameter portion 12b to be continuous with each other. The upper punch 13 is capable of being raised and lowered integrally with the core rod 11.

First, as illustrated in FIG. 6, a lower end of the bearing preform 8′ is inserted along an inner periphery of the die 12, and the small-diameter portion 8d3′ on the outer peripheral surface 8d′ of the bearing preform 8′ and the large-diameter portion 12a on the inner peripheral surface of the die 12 are fitted to each other through a radial gap. Along therewith, the core rod 11 is inserted along an inner periphery of the bearing preform 8′, and the inner peripheral surface 8a′ of the bearing preform 8′ and the outer peripheral surface of the core rod 11 are fitted to each other through a radial gap. Then, a lower end of the large-diameter portion 8d2′ on the outer peripheral surface 8d′ of the bearing preform 8′ is brought into abutment against the die 12, and the upper punch 13 is brought into abutment against the upper end surface 8c′ of the bearing preform 8′. At this time, preset forming regions for the bearing surfaces 8a1 and 8a2 in the inner peripheral surface 8a′ of the bearing preform 8′ and the molding patterns 20 on the outer peripheral surface of the core rod 11 are opposed to each other in the radial direction.

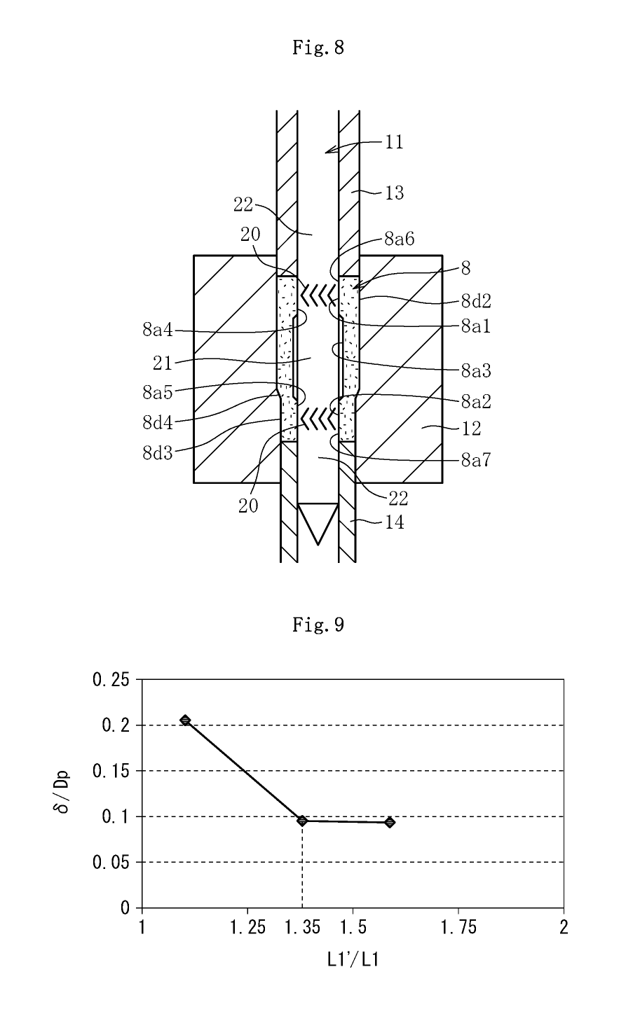

Then, the upper end surface 8c′ of the bearing preform 8′ is pushed downward by the upper punch 13 while the relative positional relationship between the bearing preform 8′ and the core rod 11 is maintained. With this, the large-diameter portion 8d2′ on the outer peripheral surface 8d′ of the bearing preform 8′ is press-fitted along the large-diameter portion 12a of the die 12 to press this region radially inward. With this, the upper region of the inner peripheral surface 8a′ of the bearing preform 8′ is pressed against the molding pattern 20 on the upper side of the core rod 11 to mold the bearing surface 8a1 having the dynamic pressure generating grooves G1 (see FIG. 8). At the same time, regions on both sides of the preset forming region for the bearing surface 8a1 in the axial direction in the inner peripheral surface 8a′ of the bearing preform 8′ is pressed against the first cylindrical region 21 and the second cylindrical region 22 adjacent to the molding pattern 20 on the upper side of the core rod 11 to mold the first smooth surface 8a4 and the second smooth surface 8a6 adjacent to both sides of the bearing surface 8a1 in the axial direction. At this time, the large-diameter portion 8d2′ on the outer peripheral surface 8d′ of the bearing preform 8′ is press-fitted along the large-diameter portion 12a of the die 12 so that the large-diameter portion 8d2′ is radially contracted to have a diameter substantially equal to that of the small-diameter portion 8d3′. With this, on the outer peripheral surface 8d of the fluid dynamic bearing 8, the large-diameter portion 8d2 having a straight cylindrical surface shape is formed. The pressure mark P1 is formed in a region of the large-diameter portion 8d2 in which the large-diameter portion 8d2′ on the outer peripheral surface 8d′ of the bearing preform 8′ which is previously present (see FIG. 3).

Further, the bearing preform 8′ is pushed downward by the upper punch 13. Thus, the lower end of the small-diameter portion 8d3′ on the outer peripheral surface 8d′ of the bearing preform 8′ is press-fitted along the small-diameter portion 12b through the tapered portion 12c on the inner peripheral surface of the die 12 to press this region radially inward. With this, the lower region of the inner peripheral surface 8a′ of the bearing preform 8′ is pressed against the molding pattern 20 on the lower side of the core rod 11 to mold the bearing surface 8a2 having the dynamic pressure generating grooves G2 (see FIG. 8). At the same time, regions on both sides of the preset forming region for the bearing surface 8a2 in the axial direction in the inner peripheral surface 8a′ of the bearing preform 8′ is pressed against the first cylindrical region 21 and the second cylindrical region 22 adjacent to the molding pattern 20 on the lower side of the core rod 11 to mold the first smooth surface 8a5 and the second smooth surface 8a7 adjacent to both sides of the bearing surface 8a2 in the axial direction. At this time, the lower end of the small-diameter portion 8d3′ on the outer peripheral surface 8d′ of the bearing preform 8′ is press-fitted along the small-diameter portion 12b and the tapered portion 12c of the die 12 so that the lower end of the small-diameter portion 8d3′ is radially contracted. With this, the small-diameter portion 8d3 and the tapered portion 8d4 are formed on the outer peripheral surface 8d of the fluid dynamic bearing 8, and the pressure marks P2 and P2′ are formed in those regions (see FIG. 3).

In this manner, the two regions of the bearing preform 8′, which are separated from each other in the axial direction, are pressed radially inward to be radially contracted. Thus, the bearing surfaces 8a1 and 8a2 and other portions are molded. In contrast, the axial center region of the bearing preform 8′ does not receive a pressing force acting radially inward, and hence the inner peripheral surface of this region is not radially contracted. As a result, the axial center region of the inner peripheral surface 8a′ of the bearing preform 8′ has a diameter larger than those of the bearing surfaces 8a1 and 8a2, and this region serves as the relief portion 8a3. In this manner, the fluid dynamic bearing 8 comprising the bearing surfaces 8a1 and 8a2 and the relief portion 8a3 is formed.

After that, the core rod 11 and the fluid dynamic bearing 8 are raised so as to be removed from an inner periphery of the die 12. With this, the pressing force acting radially inward, which is applied to the fluid dynamic bearing 8, is released, and two regions of the inner peripheral surface 8a, which are separated from each other in the axial direction, are radially expanded due to springback to be separated from the molding patterns 20 of the core rod 11. With this, the core rod 11 can be pulled out from the inner periphery of the fluid dynamic bearing 8 without interference between the dynamic pressure generating grooves G1 and G2 of the fluid dynamic bearing 8 and the molding patterns 20 of the core rod 11.

At this time, in the inner peripheral surface 8a of the fluid dynamic bearing 8, amounts of radial expansion of the regions molded by being pressed by the core rod 11 (bearing surfaces 8a1 and 8a2, first smooth surfaces 8a4 and 8a5, and second smooth surfaces 8a6 and 8a7) are not uniform. In particular, among the above-mentioned regions, parts adjacent to the relief portion 8a3 are pulled to the radially outer side by the relief portion 8a3, and hence amounts of radial expansion of the parts are slightly larger. In this embodiment, the first smooth surfaces 8a4 and 8a5 are formed in the parts, and hence the first smooth surfaces 8a4 and 8a5 are inclined surfaces having a diameter slightly increased toward the relief portion 8a3 side. As described above, the bearing surfaces 8a1 and 8a2 and the relief portion 8a3 are not adjacent to each other, but the first smooth surfaces 8a4 and 8a5 are formed therebetween. Thus, such a situation that an influence by the relief portion 8a3 reaches the bearing surfaces 8a1 and 8a2 can be avoided, thereby being capable of preventing shear droop at each of the end portions of the bearing surfaces 8a1 and 8a2 on the relief portion 8a3 side.

Further, both the chamfered portions 8e′ and 8f′ (see FIG. 5) of the bearing preform 8′ are not held in contact with the die in the sizing step, and are not molded. In this case, when the bearing preform 8′ is pressed radially inward, a pressing force applied to an upper end and a lower end of the inner peripheral surface 8a′ of the bearing preform 8′, that is, regions adjacent to the chamfered portions 8f′ is liable to escape to the chamfered portions 8f′. Thus, there is a fear in that those regions are not pressed against the outer peripheral surface of the core rod 11 sufficiently. In this embodiment, the bearing surfaces 8a1 and 8a2 and the chamfered portions 8f′ are not adjacent to each other, but the second smooth surfaces 8a6 and 8a7 are formed therebetween. Thus, an influence by the chamfered portions 8f′ is less liable to reach the bearing surfaces 8a1 and 8a2, thereby being capable of preventing degradation in molding accuracy of the bearing surfaces 8a1 and 8a2.

As described above, in this embodiment, the first smooth surfaces 8a4 and 8a5 and the second smooth surfaces 8a6 and 8a7, which are formed in the regions adjacent to the respective bearing surfaces 8a1 and 8a2, fulfill a function of absorbing degradation in surface accuracy (for example, cylindricity) due to the influences by the relief portion 8a3 and the chamfered portions 8f, thereby being capable of molding the bearing surfaces 8a1 and 8a2 with high accuracy. With this, the oil film formation ability by the bearing surfaces 8a1 and 8a2 can be enhanced, thereby being capable of enhancing the bearing rigidity of the radial bearing portions R1 and R2.

In particular, when the bearing span of the fluid dynamic bearing 8 is set large as in this embodiment, a force for supporting a moment load applied to the shaft 2 can be increased. As described above, the first smooth surfaces 8a4 and 8a5 and the second smooth surfaces 8a6 and 8a7 adjacent to the bearing surfaces 8a1 and 8a2 are formed on the inner peripheral surface 8a of the fluid dynamic bearing 8 having a large bearing span. Thus, the molding accuracy for the bearing surfaces 8a1 and 8a2 is enhanced, thereby attaining further enhancement of a supporting force.

Further, when both ends of the outer peripheral surface 8d′ of the bearing preform 8′ in the axial direction are pressed radially inward in the sizing step, regions adjacent to the pressed regions are slightly radially contracted. Therefore, regions having a slightly small diameter are formed at both ends of the relief portion 8a3 in the axial direction. In the fluid dynamic bearing 8 of this embodiment, an axial interval between the bearing surfaces 8a1 and 8a2 is large. Thus, even when the first smooth surfaces 8a4 and 8a5 adjacent to the bearing surfaces 8a1 and 8a2 are formed, an axial dimension of the relief portion 8a3 can be sufficiently secured. Therefore, even when small-diameter regions are formed on both the ends of the relief portion 8a3 in the axial direction, the large-diameter region at the axial center can be sufficiently secured, thereby being capable of preventing increase in rotational torque of the shaft 2.

The present invention is not limited to the above-mentioned embodiment. Now, description is made of other embodiments of the present invention. Description of features which are the same as those of the embodiment described above is omitted.

Radial positions of the first smooth surfaces 8a4 and 8a5 and the second smooth surfaces 8a6 and 8a7 are not limited to those described above. For example, one or both of the first smooth surfaces 8a4 and 8a5 and the second smooth surfaces 8a6 and 8a7 may be formed so as to be continuous with the hill portions of the bearing surfaces 8a1 and 8a2. However, in order to reduce the rotational torque of the shaft 2, it is preferred that the first smooth surfaces 8a4 and 8a5 and the second smooth surfaces 8a6 and 8a7 be increased in diameter as much as possible. Therefore, it is desired that the first smooth surfaces 8a4 and 8a5 and the second smooth surfaces 8a6 and 8a7 be formed so as to be continuous with the dynamic pressure generating grooves G1 and G2 as in the above-mentioned embodiment.

The shapes of the dynamic pressure generating grooves G1 and G2 are not limited to those described above. For example, the annular shape regions formed at the axial centers of the hill portions of the respective bearing surfaces 8a1 and 8a2 may be omitted, and the dynamic pressure generating grooves G1 and G2 may be formed so as to be continuous with each other in the axial direction. Further, the radial grooves 9b1 and 7b3 formed in the lower end surface 9b of the sealing member 9 and the shoulder surface 7b2 of the housing 7 may be formed in the upper end surface 8c and the lower end surface 8b of the fluid dynamic bearing 8, respectively.

The thrust bearing portion T is not limited to the configuration configured to support the shaft 2 in a contact manner as described above, and may be configured to support the shaft 2 in a non-contact manner by a dynamic pressure generating action of a fluid film. For example, the following configuration may be employed. Specifically, a flange portion is formed on the lower end of the shaft 2, and thrust bearing gaps are formed between an upper end surface of the flange portion and the lower end surface 8b of the fluid dynamic bearing 8 and between a lower end of the flange portion and the upper end surface 7b1 of the bottom 7b of the housing 7, respectively. The shaft 2 is supported in both thrust directions by dynamic pressure generating actions generated in both the thrust bearing gaps. In this case, it is desired that dynamic pressure generating grooves be formed in both the end surfaces of the flange portion or the lower end surface of the fluid dynamic bearing and the upper end surface of the bottom 7b of the housing 7. Further, in this case, it is preferred that lubricating oil be filled in an internal space of the fluid dynamic bearing device 1 including inner pores of the fluid dynamic bearing 8. At this time, a tapered surface is formed on one or both of the inner peripheral surface 9a of the sealing member 9a and the outer peripheral surface 2a of the shaft 2, and a wedge-shaped seal space having a radial width gradually reduced toward the lower side is formed. The oil surface is always kept in the seal space.

The present invention is not limited to the fluid dynamic bearing having a large bearing span (specifically, the ratio L/D of the axial length L to the inner diameter D is 5 or more), and may be applied to a fluid dynamic bearing having a normal bearing span (for example, L/D is 4 or less).

The above-mentioned fluid dynamic bearing device is not limited to the configuration in which the fluid dynamic bearing 8 is fixed, and the shaft 2 is rotated, but may have a configuration in which the shaft 2 is fixed, and the fluid dynamic bearing 8 is rotated, or a configuration in which both the shaft 2 and the fluid dynamic bearing 8 are rotated.

Further, the above-mentioned fluid dynamic bearing device is widely applicable not only to a fan motor, but also to a spindle motor for information equipment, a polygon scanner motor for a laser beam printer, a color wheel for a projector, or other small motors.

### Example 1

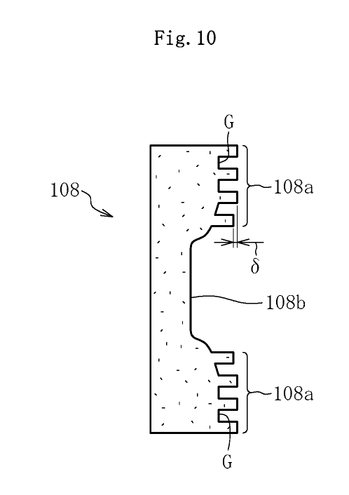

In order to verify a preferred condition of the present invention, the following test was conducted. First, a plurality of kinds of test pieces having a similar configuration to that of the fluid dynamic bearing 8 illustrated in FIG. 3, which differed in axial dimension of the first smooth surface 8a4, were prepared. Specifically, there were prepared the plurality of test pieces, which differed in ratio L1′/L1 of the axial distance L1′ (axial dimension of pressure mark P2) between the lower end surface 8b of the fluid dynamic bearing 8 and the upper end of the first smooth surface 8a5 on the lower side (lower end of the relief portion 8a3) to the axial distance L1 between the lower end surface 8b of the fluid dynamic bearing 8 and the upper end of the bearing surface 8a2 on the lower side. Then, a dimension of shear droop δ at the end portion of the bearing surface 8a2 on the relief portion 8a3 side of each of test pieces (see FIG. 10) and a depth Dp of the dynamic pressure generating grooves G1 were measured, and a ratio δ/Dp of the shear droop δ to the depth Dp was calculated.

FIG. 9 is a graph for showing a relationship between a value of L1′/L1 and a value of δ/Dp of each of the test pieces. Based on the graph, it is found that, as the value of L1′/L1 is increased, the value of δ/Dp is reduced, when the value of L1′/L1 exceeds 1.25, the value of δ/Dp becomes 0.15 or less, and when the value of L1′/L1 exceeds 1.35, the value of δ/Dp becomes constant at about 0.1. From those results, it is verified that, when the value of L1′/L1 is set to 1.25 or more, preferably, 1.35 or more, the shear droop δ at the bearing surface can be sufficiently suppressed. Further, when the value of L1′/L1 is excessively increased, the effect of suppressing the shear droop δ at the bearing surface is not enhanced, and, rather, the area of the first smooth surface 8a5 is excessively increased, thus leading to increase in rotational torque of the shaft 2. Therefore, it is desired that the value of L1′/L1 be 2 or less, preferably, 1.5 or less.

### REFERENCE SIGNS LIST

1 fluid dynamic bearing device
2 shaft
7 housing
8 fluid dynamic bearing
8′ bearing preform
8a inner peripheral surface
8a1, 8a2 bearing surface
8a3 relief portion
8a4, 8a5 first smooth surface
8a6, 8a7 second smooth surface
9 sealing member
10 thrust receiver
11 core rod
12 die
13 upper punch
14 lower punch
20 molding pattern
21 first cylindrical region
22 second cylindrical region
G1, G2 dynamic pressure generating groove
P1, P2, P2′ pressure mark
R1, R2 radial bearing portion
T thrust bearing portion
S seal space

1. A fluid dynamic bearing, comprising:
an inner peripheral surface comprising:
a pair of bearing surfaces, which are formed in two regions separated from each other in an axial direction, and have dynamic pressure generating grooves;
a pair of first smooth surfaces formed between the pair of bearing surfaces so as to be adjacent to the respective bearing surfaces; and
a relief portion formed between the pair of first smooth surfaces, and has a diameter larger than a diameter of the pair of bearing surfaces; and
an outer peripheral surface having pressure marks formed in entire axial regions covering the pair of bearing surfaces and the pair of first smooth surfaces.

2. The fluid dynamic bearing according to claim 1, wherein each of the first smooth surfaces has a diameter gradually increased toward the relief portion side.

3. The fluid dynamic bearing according to claim 1, wherein each of the first smooth surfaces is formed so as to be continuous with the dynamic pressure generating grooves of each of the bearing surfaces adjacent to the each of the first smooth surfaces.

4. The fluid dynamic bearing according to claim 1, further comprising a pair of second smooth surfaces formed on outer sides of the pair of bearing surfaces in the axial direction so as to be adjacent to the respective bearing surfaces.

5. The fluid dynamic bearing according to claim 4, wherein each of the second smooth surfaces is formed so as to be continuous with the dynamic pressure generating grooves of each of the bearing surfaces adjacent to the each of the second smooth surfaces.

6. The fluid dynamic bearing according to claim 1, wherein a ratio L/D of an axial length L to an inner diameter D is 5 or more.

7. The fluid dynamic bearing according to claim 1, wherein an axial distance between one axial end surface of the fluid dynamic bearing and an end portion of one of the first smooth surfaces, which is close to the one axial end surface, on the relief portion side is set to more than 1.25 times larger than an axial distance between the one axial end surface and an end portion of one of the bearing surfaces, which is close to the one axial end surface, on the relief portion side.

8. A fluid dynamic bearing device, comprising:
the fluid dynamic bearing of claim 1;
a shaft inserted along an inner periphery of the fluid dynamic bearing; and
a radial bearing portion configured to support the shaft in a non-contact manner by a pressure of a lubricating fluid filled in a radial bearing gap between the pair of bearing surfaces of the fluid dynamic bearing and an outer peripheral surface of the shaft.

9. A motor, comprising:
the fluid dynamic bearing device of claim 8;
a stator coil; and
a rotor magnet.

10. A method of manufacturing a fluid dynamic bearing, comprising:
inserting a core rod along an inner periphery of a bearing preform having a cylindrical shape, the core rod comprising a pair of molding patterns separated from each other in an axial direction and a first cylindrical region formed between the pair of molding patterns so as to be adjacent to the respective molding patterns, which are formed on an outer peripheral surface of the core rod; and
pressing two regions of an inner peripheral surface of the bearing preform, which are separated from each other in the axial direction, against the molding patterns and the first cylindrical region of the core rod by pressing two regions of an outer peripheral surface of the bearing preform, which are separated from each other in the axial direction, radially inward to mold, on the inner peripheral surface of the bearing preform, a pair of bearing surfaces having dynamic pressure generating grooves and a pair of first smooth surfaces formed between the pair of bearing surfaces so as to be adjacent to the respective bearing surfaces, and to form a relief portion between the pair of first smooth surfaces, the relief portion having a diameter larger than a diameter of the pair of bearing surfaces.

11. The method of manufacturing the fluid dynamic bearing according to claim 10,
wherein a pair of second cylindrical regions adjacent to the respective molding patterns are formed on outer sides of the pair of molding patterns in the axial direction in the outer peripheral surface of the core rod, and
wherein, when the two regions of the outer peripheral surface of the bearing preform, which are separated from each other in the axial direction, are pressed, the two regions of the inner peripheral surface of the bearing preform, which are separated from each other in the axial direction, are further pressed against the pair of second cylindrical regions of the core rod to mold a pair of second smooth surfaces on the inner peripheral surface of the bearing preform on outer sides of the pair of bearing surfaces in the axial direction so as to be adjacent to the respective bearing surfaces.

12. The method of manufacturing the fluid dynamic bearing according to claim 10, wherein a ratio L/D of an axial length L to an inner diameter D of the fluid dynamic bearing is 5 or more.

13. The method of manufacturing the fluid dynamic bearing according to claim 10, wherein an axial distance between one axial end surface of the fluid dynamic bearing and an end portion of one of the first smooth surfaces, which is close to the one axial end surface, on the relief portion side is set to more than 1.25 times larger than an axial distance between the one axial end surface of the fluid dynamic bearing and an end portion of one of the bearing surfaces, which is close to the one axial end surface, on the relief portion side.
